(19) United States
(12) Patent Application Publication
(10) Pub. No.: US 2011/0207378 A1
(43) Pub. Date: Aug. 25, 2011

(54) USE OF POLYMERISABLE RESINS WITH LOW VACUUM OUTGASSING FOR THE MANUFACTURE OF COMPOSITE MATERIALS FOR USE IN SPACE

(75) Inventors: Brigitte Defoort, Saint Medard en Jalles (FR); Roman Mahias, Brodeaux (FR); Dominiqu Lacour, Treses (FR); Xavier Coqueret, Reims (FR); Marion Mille, Reims (FR)

(73) Assignees: ASTRIUM SAS, Paris (FR); UNIVRSITE DE REIMS, Reims Cedex (FR); CENTRE NATIONAL DE LA RECHERCHE SCIENTIFIQUE, Paris (FR)

(21) Appl. No.: 13/059,957

(22) PCT Filed: Aug. 26, 2009
(86) PCT No.: PCT/EP2009/060969

§ 371 Date: May 10, 2011

(30) Foreign Application Priority Data
Aug. 28, 2008 (FR) 08 55766

(51) Int. Cl. B32B 27/04; B32B 27/38; C08F 136/06; C08F 236/14; C08L 61/14; C08L 9/00; C08K 3/34

(52) U.S. Cl. 442/1; 525/333.2; 525/332.8; 525/139; 524/511; 524/443; 525/138

(57) ABSTRACT

A method of using at least one polymerisable resin R1 is disclosed. According to some aspects, the resin R1 is selected from the group consisting of epoxidised polybutadiene resins, epoxidised polyisoprene resins, epoxidised polysiloxane resins, epoxidised triglyceride resins and epoxidised polyether resins. The resin R1 having at the non-polymerised state a total mass loss (TML) value lower than about 10%, a recovered mass loss (RML) value lower than about 10%, and a collected volatile condensable material (CVCM) value lower than about 1%, as determined in accordance with standard ECSS-Q-70-02A of the European Space Agency. The resin R1 also characterized by an epoxide equivalent weight of about 100 to 600 g/mole. The resin is configured for the manufacture of a composite material for use in space, and more specifically, a composite material of a Gossamer structure. Polymerisable resin compositions are also disclosed which are useful in the manufacture of composite materials for use in space.

### TECHNICAL FIELD

This invention relates to the use of particular polymerisable resins for the manufacture of composite materials for use in space and, more specifically, composite materials intended to enter into the composition of structures to be deployed by inflating, also known by the name of “Gossamer structures”.

The invention likewise relates to polymerisable resin compositions useful for the manufacture of composite materials for use in space, as well as such composite materials.

### PRIOR ART

The limited volume beneath the nose cones of space launch vehicles has led to the designing of structures which are launched folded-over and which deploy once same have arrived in space, which is, in particular, the case of Gossamer structures.

These structures, which, in particular, can be solar panels, reflectors, sunscreens, antennas, mirrors, solar sails or the like, include an assembly of generally tubular hollow elements, which consist of fine membranes pleated so as to form a bellows, and the deployment in space of which results from the filling thereof with a pressurised gas, which is stored in an adjoining tank.

Once deployed in space, Gossamer structures must be rigidified in order to be capable of withstanding possible impacts with meteorites.

This is the reason why it has been proposed to make the membranes of the Gossamer structures from fibrous materials, e.g., carbon fibre fabrics or Kevlar, which are impregnated with a polymerisable resin-based composition, and to induce the polymerisation of this resin by temperature or ultraviolet radiation, after said structures have been deployed in space.

It is well known that, in the vacuum, materials degas either because the surface thereof has been polluted or because they contain or generate via degradation volatile compounds.

Such being the case, said outgassing has harmful consequences. Indeed, if the volatile compounds are components of the material which degasses or result from the degradation of components of said material, then the latter can lose the properties thereof at the same time as the components thereof. Furthermore, outgassing generally constitutes pollution of the environment. Thus, for example, in the case of a space probe, it can lead to the formation of deposits on the optical instruments, which can in turn lead to the loss of functionality of said instruments.

As specifically concerns the outgassing in space of polymerisable resins entering into the composition of Gossamer structures, there is extremely little data in literature.

In fact, existing data is limited to an article by Cadogan and Scaborough, which was published in 2001 by the American Institute of Aeronautics and Astronautics (AIAA Gossamer Spacecraft Forum, 16-19 Apr. 2001, Seattle, Wash.) and in which these authors minimise the importance of said outgassing and, as a result, the consequences thereof. Indeed, Cadogan and Scaborough consider that outgassing would be extremely limited due to the fact that the layers of fibrous material impregnated with resin are sandwiched between two gas-tight films.

In reality, it proves true that the polymer films the use of which is promoted for producing the walls of Gossamer structures are not truly gas-tight. Furthermore, experience demonstrates that it is even desirable for the walls of Gossamer structures to be at least partially gas-permeable (as described in PCT international application published under No. WO 2006/024805), in order to prevent maintaining air pockets between the layers of fibrous material, which are liable to cause deformation of said structures and interfere with the deployment thereof in space.

The problem of the harmful consequences of outgassing the polymerisable resins present in Gossamer structures in space is therefore quite real.

A certain number of patent documents address the outgassing of polymerisable resins. However, it bears noting that, not only these documents aim at uses (packagings, fire protection, Woodburytype for microprocessors, microelectronics, . . . ) which have nothing to do with the space field, but that, moreover, the objective thereof is to prevent outgassing after polymerisation of the resins or during depolymerisation of said resins while, in the case of Gossamer structures, it is predominantly the outgassing which occurs before the resins polymerise which is problematic.

Therefore, the inventors make it their objective to find polymerisable resins which do not degas or only very little when same are subjected to conditions of pressure and temperature similar to those which prevail in a space environment.

They also made it an objective for these resins to have physicochemical characteristics compatible with use in the manufacture of composite materials for use in space, in particular as concerns the feasibility of impregnating fibrous materials such as those conventionally used in the space field and the mechanical properties of the resulting composite materials.

### DISCLOSURE OF THE INVENTION

These objectives and others as well are achieved by this invention, which relates firstly to the use of at least one polymerisable resin R1 selected from the group consisting of epoxidised polybutadiene resins, epoxidised polyisoprene resins, epoxidised polysiloxane resins, epoxidised triglyceride resins and epoxidised polyether resins having at the non-polymerised state:
on the one hand, a total mass loss value (TML) lower than 10%, a recovered mass loss (RML) value lower than 10%, and a collected volatile condensable material (CVCM) value lower than 1%, said values being determined in accordance with standard ECSS-Q-70-02A of the European Space Agency; and
on the other hand, an epoxide equivalent weight (EEW) of 100 to 600 g/mole;

for the manufacture of a composite material for use in space.

In the preceding and in what follows, a polymerisable resin is understood to mean both a resin which can consist only of monomers, prepolymers or a mixture of monomers and prepolymers, as well as a resin which, in addition to the monomers and/or prepolymers, includes additives, for example, such as an initiator, a polymerisation accelerator or inhibitor, an antioxidant, or a reactive or non-reactive diluent, as is often the case with commercially available polymerisable resins.

As concerns epoxidised triglyceride resins, the reader may refer to the articles by Güner et al. (Prog. Polym. Sci. 2006, 31, 633-670) and by Sperling and Manson (JAOCS 1983, 60(11), 1887-1892). Such resins, for example, are the Vikoflex® resins marketed by the Arkema Company.

In addition, polymerisation is understood to mean not only the formation of polymer chains via bonding of monomers and prepolymers with one another, but likewise the formation of a three-dimensional network via the establishment of bonds between said polymer chains, which is commonly called cross-linking.

The outgassing test of standard ECSS-Q-70-02A consists in conditioning samples of the material for which it is desired to test the outgassing tendency by leaving said samples for 24 hours (t₀→t₂₄) at a temperature of (22±3)° C. and at a relative humidity of (55±10) %, and in then subjecting said samples to thermogravimetric analysis, which is carried out for 24 hours (t₂₄→t₄₈), at a temperature of 125° C. and under a vacuum of at least 10⁻³ Pa, and in once again conditioning the samples while leaving them for 24 hours (t₄₈→t₇₂) at a temperature of (22±3)° C. and a relative humidity of (55±10)%.

In this way, determination is made of:
the TML, which corresponds to the total mass loss of the samples during thermogravimetric analysis, i.e., between t₂₄ and t₄₈, and which is expressed as a percentage of the mass of the samples at t₂₄;
the RML, which corresponds to the total mass loss of the samples exclusive of the water moisture regain of the samples, i.e., the water vapour mass absorbed by the samples between t₄₈ and t₇₂, and which is expressed as a percentage of the mass of the samples at t₂₄; and
the CVCM, which corresponds to the quantity of matter released by the outgassing of the samples during thermogravimetric analysis and that condenses on a collector, and which is likewise expressed as a percentage of the mass of the samples at t₂₄.

The greater the outgassing tendency of a material, the lower the TML, RML and CVCM values thereof.

As for the epoxide equivalent weight (EEW), this corresponds to the mass of resin, in grams, which contains 1 mole of an epoxide group.

According to the invention, the resin R1 is preferably chosen from the epoxidised polybutadiene resins and, more especially, from resins which comprise prepolymers comprising repetitive units having formulas (I), (II) and (III) below:

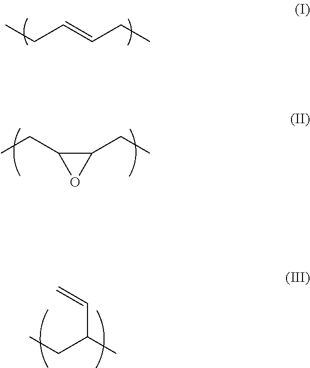

as well as two hydroxyl reactive end-groups.

Polymerisable resins of this type are, for example, the epoxidised polybutadiene resins having hydroxyl end-groups, which are marketed by the Sartomer Company under the trade names Poly Bd® 600E and Poly Bd® 605E.

These resins, the prepolymers of which comply schematically with formula (IV) below:

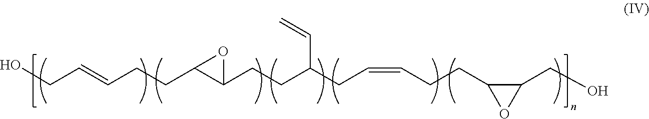

wherein n corresponds to the number of repetitive units present between the brackets, typically have the following physicochemical characteristics:
a molecular weight of approximately 1300;
an EEW of 400-500 g/mole for the Poly Bd® 600E resin and 260-330 g/mole for the Poly Bd® 605E resin;
a viscosity of 7 Pa·s at 30° C. for the Poly Bd® 600E resin and 22 Pa·s for the Poly Bd® 605E resin;
a hydroxyl value of 1.70 meq/g for the Poly Bd® 605E resin.

The aforementioned polymerisable resins, and in particular the elastomeric-type resins such as the epoxidised polybutadiene or polyisoprene resins, typically have a glass transition temperature (or Tg) lower than the ambient temperature and consequently, after polymerisation, result in polymers having a relatively low Young's modulus.

Therefore, within the scope of the invention, it is preferred to use these resins in conjunction with at least one other polymerisable resin R2 which similarly outgases little but which has a glass transition temperature significantly higher than the ambient temperature.

This resin R2 is preferably selected from the group consisting of the novolac-type epoxide resins and the epoxide resins of the bisphenol A diglycidyl ether (DGEBA) type, which, in the non-polymerised state, have a TML value lower than 10%, an RML value lower than 10% and a CVCM value lower than 1%, as determined in accordance with the standard ECSS-Q-70-02A, as well as an EEW of 100 to 600 g/mole.

Resins which meet these criteria are, in particular, the novolac epoxide resins EPON® Su-4 and EPON® Su-8 of the Hexion Specialty Chemicals Corporation and the Tactix® 742 resin of the Huntsmann Company.

According to the invention, it is preferred that, in the non-polymerised state, the mixture of resins R1 and R2 has:
on the one hand, a viscosity of 0.2 to 4 Pa·s and, better yet, from 0.8 to 1 Pa·s at the temperature at which the fibrous material intended to enter into the composition of the composite material is impregnated, which is typically from 40 to 60° C.; and
on the other hand, a total mass loss (TML) value lower than 5%, a recovered mass loss (RML) value lower than 5% and a collected volatile condensable material (CVCM) value lower than 1%, as determined in accordance with the standard ECSS-Q-70-02A.

The R1 and R2 resins and the relative proportions thereof in the mixture are therefore adjusted accordingly.

For example, a mixture of resins satisfying the above requirements was obtained by mixing a Poly Bd® 605E-type epoxidised polybutadiene resin having hydroxyl end-groups with an EPON® Su-8-type novolac epoxide resin, in a mass ratio ranging from 1/3 to 3/1.

According to the invention, the R1 resin or the mixture of R1 and R2 resins can likewise be used in conjunction with at least one additive selected from the group consisting of polymerisation initiators, cross-linking agents (or hardeners), compatibilisers and fillers. All of these additives are, inasmuch as possible, selected from the compounds which outgas little, i.e., which, for all practical purposes, satisfy the same outgassing criteria as those defined previously for the R1 and R2 resins.

As a polymerisation initiator, it is preferred to use:
either a photoinitiator enabling polymerisation to be initiated, preferably cationically, when exposed to light radiation, if possible situated in the visible range, such as a salt, e.g., a hexafluorophosphate, of the 1-methylnaphthalene iron-cyclopentadienyl complex, as described in the PCT international application published under the No. WO 2006/043009;
or a thermal initiator enabling polymerisation to be initiated, preferably cationically, when the temperature is increased, such as a salt (bromide, chloride . . . ) of n-butylpyridinium, benzylpyrazinium or an onium salt.

In both cases, the polymerisation initiator is preferably used in an amount of 0.5 to 5% by mass and, better yet, from 1 to 3% by mass of the mass of resin R1 or of the mixture of R1 and R2 resins.

As a cross-linking agent, a compound is preferably used which is selected from the amines, phenols and acid anhydrides. This cross-linking agent is advantageously used in stoichiometric proportions in relation to the R1 resin or to the mixture of R1 and R2 resins.

As a compatibiliser, a compound is preferably used which is selected from the styrene-butadiene or epoxidised styrene-butadiene-styrene block copolymers. Said compatibiliser is preferably used in an amount of a few percents by mass.

As fillers, fillers are preferably used which are capable of conferring specific properties on the composite material, e.g., such as electrical conductibility properties, which are obtained by the addition of carbon black or carbon nanotubes.

According to the invention, the composite material is obtained by impregnating a fibrous material with the R1 resin or the mixture of R1 and R2 resins. This impregnation, which can be carried out by any of the prepeg manufacturing techniques known to those skilled in the art (in this regard, see “TECHNIQUES DE L'INGENIEUR”, Plastiques et Composites, volume AM5), is preferably carried out at a temperature ranging from 40 to 60° C.

The fibrous material can be of various types. Thus, it can be a material consisting of glass fibres, quartz fibres, carbon fibres, graphite fibres, silica fibres, metallic fibres such as steel fibres, aluminium fibres or boron fibres, organic fibres such as aramid fibres, polyethylene fibres, polyester fibres or poly(p-phenylene-benzobisoxazole) fibres, better known by the acronym BPO, or else silicon carbide fibres.

Said fibrous material, depending on the nature of the fibres comprising same, can be in the form of clipped threads, milled fibres, continuous filament mats, cut filament mats, rovings, woven fabrics, knit fabrics, felts . . . , or else in the form of complexes made by combining various types of flat materials.

According to one particular preferred arrangement of the invention, the composite material for use in space is a composite material of a Gossamer structure, in which case the fibrous material present in said composite material is advantageously made of glass fibres.

However, it stands to reason that the composite material can likewise be intended for any other type of structure for use in space, like for example as walls for inflatable habitats rigidified by polymerisation of resins or rope structures like those described in the French patent application published under the number 2 887 523.

The invention likewise relates to a resin composition useful in manufacturing a composite material for use in space, which comprises:
at least one polymerisable resin R1 selected from the group consisting of epoxidised polybutadiene resins, epoxidised polyisoprene resins, epoxidised polysiloxane resins, epoxidised triglyceride resins and epoxidised polyether resins, and
at least one polymerisable resin R2 selected from the group consisting of novolac-type epoxide resins and epoxide resins of the bisphenol A diglycidyl ether type, resins R1 and R2 having, in the non-polymerised state, a total mass loss (TML) value lower than 10%, a recovered mass loss (RML) value lower than 10%, and a collected volatile condensable material (CVCM) value lower than 1%, as determined in accordance with standard ECSS-Q-70-02A, as well as an epoxide equivalent weight (EEW) of 100 to 600 g/mole.

In this composition, the preferred characteristics of the R1 and R2 resins are exactly the same as those indicated previously for the use of the R1 polymerisable resin. The viscosity of this composition, the outgassing properties thereof and the additives that it is capable of containing are likewise entirely the same as those indicated previously for the use of the R1 polymerisable resin.

The invention also relates to a composite material for use in space and, in particular, a composite material of a Gossamer structure, which comprises a fibrous material impregnated with a resin composition as described previously.

Said fibrous material is preferably selected from the group consisting of glass fibres, quartz fibres, carbon fibres, graphite fibres, metallic fibres, poly(p-phenylene-benzobisoxazole) fibres, aramid fibres, polyethylene fibres, boron fibres, silicon carbide fibres and the mixtures thereof, the materials made of glass fibres being most especially preferred.

Other features and advantages of the invention will become apparent from the following supplementary description which relates to exemplary embodiments of resin compositions according to the invention demonstrating the properties thereof.

Of course, said supplementary description is given solely for purposes of illustrating the invention and under no circumstances constitutes a limitation thereof.

### DISCLOSURE OF PARTICULAR EMBODIMENTS

### 1) Preparation of Resin Compositions According to the Invention

Resin compositions are prepared which consist of:
from 25 to 75% by mass of the hydroxyl-terminated epoxidised polybutadiene resin which is marketed by the Sartomer Company under the trade name Poly Bd® 605E, hereinafter designated as resin 1, and
from 75 to 25% by mass of the novolac-type epoxide resin which is marketed by the Hexion Specialty Chemicals Corporation under the trade name EPON® SU-8, hereinafter designated as resin 2.

To accomplish this, resin 2 is heated to 120° C. until same becomes fluid, and then resin 1, which has been preheated to 70° C., is added thereto, at said same temperature. Mixing of the two resins is carried out manually.

### 2) Young's Modulus of the Resin Compositions According to the Invention, After Polymerisation

Since compositions of the resins prepared in item 1 above correspond, in the non-polymerised state, to polyphase mixtures in which the resin-rich phases 1 have a very different Tg from that of the resin-rich phases 2 (approximately −20° C. versus 70-120° C.), it was decided to estimate the mechanical properties of said compositions by measuring the Young's modulus thereof after polymerisation.

To accomplish this, after the addition of 2% by mass of hexafluorophosphate of the 1-methylnaphthalene iron-cyclopentadienyl complex, the compositions are cast into silicone moulds measuring 70 mm in length by 5 mm in width and 2 mm in thickness, and covered with a polyethylene terephthalate sheet intended to prevent same from being contaminated. They are illuminated for 24 hours by means of a Selectronic A6 flexible electro-luminescent panel (light power: 1000 lux, colour: pure white, dimensions: 150×110 mm) to induce photolysis of the photoinitiator, and then the moulds are placed in an oven at 80° C. for 2 hours.

Measurement of the Young's modulus is carried out via dynamic mechanical analysis using a visco-analysis frequency of 1 Hz.

Table I below shows the resulting modulus values for three different compositions.

TABLE I

| Composition | Young's modulus (GPa) |
|---|---|
| 30% of resin 1 | 0.9 |
| 70% of resin 2 | |
| 40% of resin 1 | 0.5 |
| 60% of resin 2 | |
| 50% of resin 1 | 0.4 |
| 50% of resin 2 | |

### 3) Feasibility of Impregnating Fibrous Materials

The resin compositions are applied at a temperature of approximately 100° C. to samples of woven fabric, which were preheated to 100° C., using a glass stirring rod.

Once the woven fabric samples have been impregnated, vacuum-draining is carried out for 2 hours at 120° C.

The feasibility of the impregnation operation is estimated on the basis of three criteria: the ease or difficulty of impregnating, the rate of impregnation and the condition of the impregnated woven fabric.

Table II below shows the results obtained for three different compositions.

TABLE II

| | | Rate of | Condition |
|---|---|---|---|
| | | impregnation | of the |
| Composition | Impregnation | (%) | woven fabric |
| 25% of resin 1 | Difficult | 29 | Dry |
| 75% of resin 2 | | | |
| 50% of resin 1 | Easy | 31 | Very |
| 50% of resin 2 | | | slight |
| | | | tackiness |
| 75% of resin 1 | Easy | 29 | Very |
| 25% of resin 2 | | | slight |
| | | | Tackiness |

### 4) Outgassing of Composite Materials Prepared from Resin 1 or from Resin Compositions According to the Invention

Samples are prepared which simulate a Gossamer structure wall, i.e., each including two plies of woven glass fibre fabric impregnated at a rate of 30% with either a resin composition according to the invention or resin 1, sandwiched between two 50 μm-thick aromatic polyamide films like those marketed by the Dupont Company under the trade name Kapton®.

Next, the outgassing tendency of said samples is estimated according to the standard ECSS-Q-70-02A. Thermogravimetric analysis is carried out for each sample, at 125° C., as prescribed by said standard, but also at 80° C., in order to fall within temperature conditions closer to those at which the resins are likely to be when the Gossamer structure is placed into orbit and the moment when polymerisation occurs after deployment of said structure.

Table 3 below shows the TML, RML and CVCM values obtained for samples prepared with three different compositions, based on the temperature at which thermogravimetric analysis was carried out: 125° C. or 80° C. It likewise shows the TML, RML and CVCM values obtained at 125° C. for the samples prepared with resin 1.

TABLE III

| | | | | |
|---|---|---|---|---|
| | TGA | | | |
| | temperature | TML | RML | CVCM |
| Composition | (° C.) | (%) | (%) | (%) |

| | | | | | |
|---|---|---|---|---|---|
| 25% of resin 1 | 125° | C. | 2.62 | 2.39 | 1.09 |
| 75% of resin 2 | | | | | |
| 50% of resin 1 | 125° | C. | 1.95 | 1.72 | 0.75 |
| 50% of resin 2 | | | | | |
| 75% of resin 1 | 125° | C. | 1.21 | 0.98 | 0.59 |
| 25% of resin 2 | | | | | |
| 100% of resin 1 | 125° | C. | 0.55 | 0.19 | 0 |
| 25% of resin 1 | 80° | C. | 0.39 | 0.18 | 0.08 |
| 75% of resin 2 | | | | | |
| 50% of resin 1 | 80° | C. | 0.42 | 0.19 | 0.06 |
| 50% of resin 2 | | | | | |
| 75% of resin 1 | 80° | C. | 0.40 | 0.18 | 0.04 |
| 25% of resin 2 | | | | | |

The results of the experimental tests shown above demonstrate that the resin compositions according to the invention enable composite materials to be obtained, the properties of which, in terms of outgassing and mechanical strength, are entirely suitable for use in space, and, in particular, for use in Gossamer structures.

### CITED REFERENCES

[1] D. P. Cadogan and S. E. Scaborough, 2001, American Institute of Aeronautics and Astronautics, AIAA Gossamer Spacecraft Forum, 16-19 Apr. 2001, Seattle, Wash.
[2] WO-A-2006/024805
[3] Güner et al., Prog. Polym. Sci. 2006, 31, 633-670
[4] Sperling and Manson, JAOCS 1983, 60(11), 1887-1892
[5] WO-A-2006/043009
[6] <<TECHNIQUES DE L′INGENIEUR>>, Plastiques et Composites, volume AM5
[7] FR-A-2 887 523

1. A method of using at least one polymerisable resin R1 selected from the group consisting of epoxidised polybutadiene resins, epoxidised polyisoprene resins, epoxidised polysiloxane resins, epoxidised triglyceride resins and epoxidised polyether resins having a non-polymerised state, the resin R1 comprising:
a total mass loss (TML) value lower than about 10%, a recovered mass loss (RML) value lower than about 10%, and a collected volatile condensable material (CVCM) value lower than about 1%, as determined in accordance with standard ECSS-Q-70-02A of the European Space Agency; and
an epoxide equivalent weight (EEW) of 100 to 600 g/mole;
the method comprising using the polymerisable resin for the manufacture of a composite material for use in space.

2. A method according to claim 1, in which the resin R1 is an epoxidised polybutadiene resin.

3. A method according to claim 2, in which the epoxidised polybutadiene resin comprises prepolymers comprising repetitive units having formulas (I), (II) and (III) below: 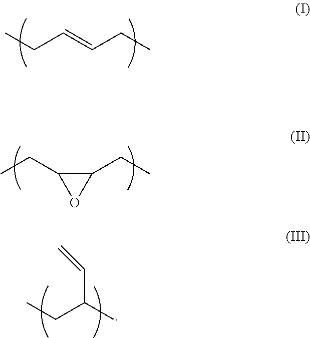
the resin R1 further comprising two hydroxyl reactive end-groups.

4. A method according to claim 1, in which the resin R1 is used in mixture with at least one other polymerisable resin R2, the resin R2 selected from the group consisting of epoxide resins of the novolac type and epoxide resins of the bisphenol A diglycidyl ether type, the resin R2, in a non-polymerised state, comprising:
a total mass loss (TML) value lower than about 10%, a recovered mass loss (RML) value lower than about 10% and a collected volatile condensable material (CVCM) value lower than about 1%, as determined in accordance with the standard ECSS-Q-70-02A; and
an epoxide equivalent weight (EEW) of about 100 to 600 g/mole.

5. A method according to claim 4, in which the resin R2 is an epoxide resin of the novolac type.

6. A method according to claim 4, in which the mixture of R1 and R2 resins, in the non-polymerised state, has a viscosity of about 0.2 to 4 Pa·s, at a temperature of about 40 to 60° C.

7. A method according to claim 4, in which the mixture of R1 and R2 resins, in the non-polymerised state, has a total mass loss (TML) value lower than about 5%, a recovered mass loss (RML) value less than about 5% and a collected volatile condensable material (CVCM) value less than about 1%, as determined in accordance with the standard ECSS-Q-70-02A.

8. A method according to claim 4, in which the mixture of R1 and R2 resins comprises an epoxidised polybutadiene resin having hydroxyl end-groups and an epoxide resin of the novolac type, in a mass ratio ranging from about 1/3 to 3/1.

9. A method according to claim 1, in which the resin R1 is used in mixture with at least one other polymerisable resin R2, and wherein the R1 resin or the mixture of the R1 and R2 resins is used in conjunction with at least one additive selected polymerisation initiators, cross-linking agents, compatibilisers and fillers.

10. A method according to claim 1, in which the resin R1 is used in mixture with at least one other polymerisable resin R2, and wherein the composite material is manufactured by impregnating a fibrous material with the R1 resin or the mixture of R1 and R2 resins.

11. A method according to claim 10, in which the fibrous material is selected from the group consisting of glass fibres, quartz fibres, carbon fibres, graphite fibres, silica fibres, metallic fibres, poly(p-phenylene-benzobisoxazole) fibres, aramid fibres, polyethylene fibres, polyester fibres, silicon carbide fibres and the mixtures thereof.

12. A method according to claim 1, in which the composite material for use in space is a composite material of a Gossamer structure.

13. A resin composition for the manufacture of a composite material for use in space, the resin composition comprising:
at least one polymerisable resin R1 selected from the group consisting of epoxidised polybutadiene resins, epoxidised polyisoprene resins, epoxidised polysiloxane resins, epoxidised triglyceride resins and epoxidised polyether resins, and
at least one polymerisable resin R2 selected from the group consisting of epoxide resins of the novolac type and epoxide resins of the bisphenol A diglycidyl ether type, resins R1 and R2 having, in the non-polymerised state, a total mass loss (TML) value lower than about 10%, a recovered mass loss (RML) value lower than about 10%, and a collected volatile condensable material (CVCM) value lower than about 1%, as determined in accordance with standard ECSS-Q-70-02A, as well as an epoxide equivalent weight (EEW) of about 100 to 600 g/mole.

14. A resin composition according to claim 13, in which the R1 resin is an epoxidised polybutadiene resin.

15. A resin composition according to claim 14, in which the epoxidised polybutadiene resin comprises prepolymers comprising repetitive units having formulas (I), (II) and (III) below: 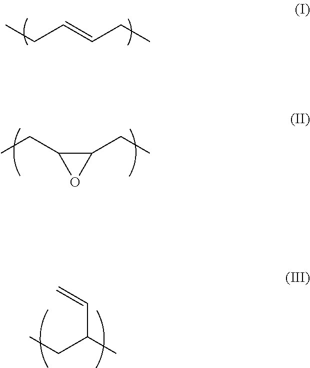
the resin composition further comprising as two hydroxyl end-groups.

16. A resin composition according to claim 13, in which the R2 resin is an epoxide resin of the novolac type.

17. A resin composition according to claim 13, which, in the non-polymerised state, has a viscosity of about 0.2 to 4 Pa·s, at a temperature of about 40 to 60° C.

18. A resin composition according to claim 13, which, in the non-polymerised state, has a total mass loss (TML) value lower than about 5%, a recovered mass loss (RML) value lower than about 0.5% and a collected volatile condensable material (CVCM) value lower than about 0.1%, as determined in accordance with the standard ECSS-Q-70-02A.

19. A resin composition according to claim 13, further comprising an epoxidised polybutadiene resin having hydroxyl end-groups and an epoxide resin of the novolac type, in a mass ratio of about 1/3 to 3/1.

20. A resin composition according to claim 13, further comprising at least one additive selected from the group consisting of polymerisation initiators, cross-linking agents, compatibilisers and fillers.

21. A composite material for use in space, the composite material comprising a fibrous material impregnated with a resin composition according to claim 13.

22. A composite material according to claim 21, in which the fibrous material is selected from the group consisting of glass fibres, quartz fibres, carbon fibres, graphite fibres, silica fibres, metallic fibres, poly(p-phenylene-benzobisoxazole) fibres, aramid fibres, polyethylene fibres, polyester fibres, silicon carbide fibres and the mixtures thereof.

23. A composite material according to claim 21, wherein the composite material is a composite material of a Gossamer structure.
